(19) United States
(12) Patent Application Publication
(10) Pub. No.: US 2014/0333658 A1
(43) Pub. Date: Nov. 13, 2014

(54) COLOR MIXING SET WITH MODELING COMPOUNDS

(71) Applicant: Shiva Zamani, East Lansing, MI (US)

(72) Inventor: Shiva Zamani, East Lansing, MI (US)

(21) Appl. No.: 13/893,285

(22) Filed: May 13, 2013

(51) Int. Cl. G06T 11/00

(52) U.S. Cl. CPC G06T 11/001
USPC 345/592

(57) ABSTRACT

A color mixing set includes containers holding a number of samples of a modeling compound, each composed of the modeling compound and a different pigment forming a different primary color, and one or more samples of the modeling compound without a pigment, for mixing to form a number of secondary colors.

### RELATED APPLICATIONS

This application claims the benefit of Provisional Patent Application No. 61/688,305, filed May 12, 2012.

### FEDERALLY SPONSORED RESEARCH OR DEVELOPMENT

Not applicable.

### BACKGROUND OF THE INVENTION

1. Field of the Invention

This invention relates to kits including modeling compounds, such as dough or clay, and, more particularly, to such kits including modeling compounds having different colors, chosen for mixing.

2. Summary of the Background Information

An interest in the development of primary colors as sets of colors that can be combined to form various other colors began in the eighteenth century with the discovery by Isaac Newton that white light is composed of a spectrum of colors that can be separated from one another by a prism, and that light within the spectrum can be recombined to form white light. It is well known that red, green, and blue light form additive primary colors that can be combined in various ratios and levels to form a wide gamut of colors, in a process widely used in color television displays and the computer displays.

The work of Isaac Newton also resulted in an interest in finding a set of subtractive primary colors that could be combined by mixing pigments for paints and other reflective objects, so that a small number of pigments could be mixed to form a wide gamut of colors. Color theorists developed a concept of a circular color wheel having colors placed around its circumference in accordance with human perceptions, and red, yellow, and blue were chosen as the subtractive primary colors, often being simply called the primary colors. This concept has survived to the present day, being used by artists in painting and being used in art education. For critical applications, such as color printing, the colors magenta (sometimes called red), cyan (sometimes called blue-green) and yellow, since these colors are known to produce a wider gamut of colors when mixed. Often, four colors—red, green, yellow, and blue—are used as primary colors for mixing paints for artistic purposes. In color printing, black pigments are often added to magenta, cyan, and yellow pigments to form better black tones and to reduce the amount of ink needed to print dark areas. The patent literature describes a paint set including a color picture to be copied and tubes of paint, including at least the primary colors, black, and white.

Modeling compounds that can be easily molded into various shapes, have been developed for use by young children in art and craft projects. A particularly popular modeling compound, in the form of a modeling dough sold under the trademark Play-Doh, has been commercially available since 1956. This compound, which is widely used by young children at home and in school settings, is a non-toxic, non-staining, reusable modeling compound that is primarily a mixture of water, salt, and flour, including a petroleum additive that gives the compound a smooth feel, borax to prevent the formation of mold, and coloring, material. Modeling doughs can also be home-made, using similar materials.

Other modeling compounds, in the form of modeling clays, are additionally available for use by children in art and craft projects. For example, oil-based modeling clays, which include various combinations of oils, waxes, and clay materials, remain malleable, since the oil-based materials do not evaporate, even when left in a dry environment, allowing the compounds to be reused by shaping into different forms, in the manner of modeling doughs.

The patent literature additionally includes descriptions of modeling compounds and descriptions of the use of colored dough in commercial baked goods.

### SUMMARY OF THE INVENTION

According to one aspect of the invention, a color mixing set is provided, including a plurality of primary samples, at least one neutral sample, a first container holding the primary samples, and at least one second containe holding the at least one neutral sampler. Each of the primary samples is composed of a modeling compound and a pigment forming a different primary color. A primary color is understood to be a color within a primary system, which is specified to allow a substantial number of secondary colors to be formed by mixing the primary colors. Each of the at least one neutral sample is composed of the modeling compound without a pigment For example, the modeling compound is a modeling dough or a modeling clay.

The first and second containers are preferably stackable upon one another, with the color mixing set additionally including a lid closing the uppermost container, which is, for example, the first container, when the containers are stacked. Alternately, the apparatus includes a third container, which holds the first and second containers when they are stacked, and a lid to close the third container. The first container may be divided into a number of compartment, each holding one of the primary samples. For example, the containers are composed of a transparent material.

The primary colors formed by the pigments in the primary samples may be red, green, and yellow, with blue optionally being added. Alternately, the primary colors may be cyan, magenta, and yellow. A primary sample including a black pigment and/or a primary sample including a white pigment, may be added.

### BRIEF DESCRIPTION OF THE DRAWINGS

These and other aspects of the invention will be made apparent by reading the following specification in conjunction with the accompanying figures, in which:

FIG. 1 is a cross-sectional elevation of a color mixing set built in accordance with the invention;

FIG. 2 is a plan view of an alternative version of the color mixing set of FIG. 1, shown with a lid removed therefrom; and

FIG. 3 is a cross-sectional elevation of a second alternative version of the color mixing set of FIG. 1.

### DETAILED DESCRIPTION OF THE INVENTION

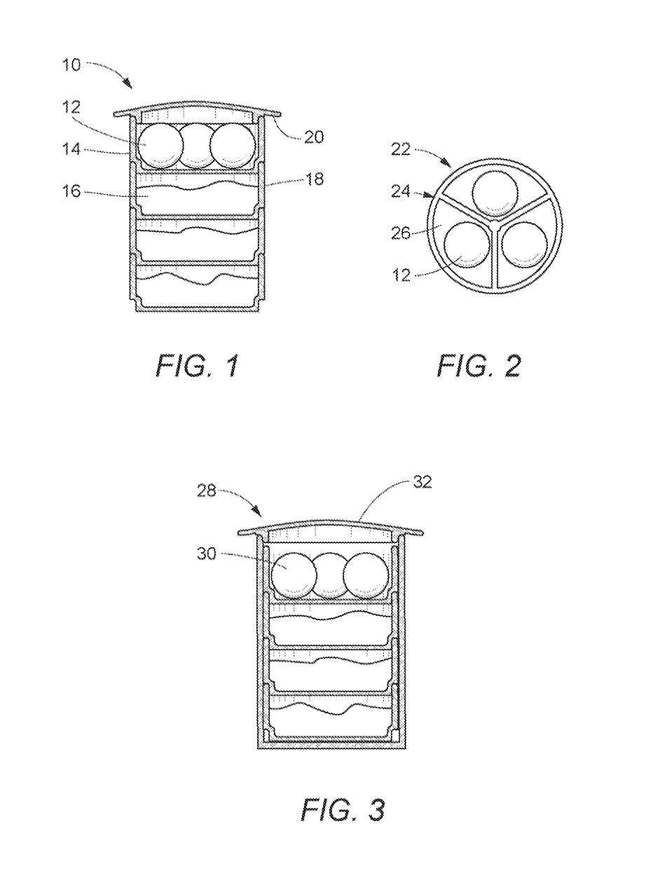

FIG. 1 is a cross-sectional elevation of a color mixing set 10, including a plurality of primary samples 12 of a modeling compound held within a first container 14 and a plurality of neutral samples 16 of the modeling compound held within a second container 18. Preferably, in each of the primary samples 12, the modeling compound is saturated with a color pigment, so that each of the colors in a system of primary colors is represented by one of the primary samples 12. Additionally, in one of the primary samples 12, the modeling compound may be saturated with a black pigment, and in another of the primary samples 12, the modeling compound may be saturated with a white pigment. Preferably, each of the neutral samples 16 is composed of the modeling compound without a pigment. Preferably, all of the primary samples 12 and all of the neutral samples 17 are composed of the same type of modeling compound, which may be a dough modeling compound or a clay modeling compound, allowing the samples 12, 17 to be mixed to form various objects of various colors. In the example of FIG. 1, the first container 14 and the second containers 18 are similar, fitting together when stacked, with a lid 20 being provided to close the first container, with the containers additionally being transparent.

The color mixing set 10 can be used as an educational tool to introduce concepts of color theory to a young child through playing simple fun games, with the child learning how primary colors can be combined with one another to form secondary colors, in an approach helping the child develop an ability to recognize and name various colors while additionally developing manual dexterity through a hands-on experience in forming various objects with the modeling compound. This hands-on experience helps maintain the child's attention while developing a sense of awareness and an intellectual understanding of color values and of the color mixing process.

The color mixing set 10 may be used as a traditional art education tool, with the system of primary colors represented by the primary samples 12 being the tradition primary colors of art education—blue, red, and yellow—with secondary colors—green, orange, and yellow—being easily formed by combining the primary colors. Alternately, an additional primary sample 12, having a green pigment, may be added to form a four-color primary system used by many painters. Alternately, a different primary color system may be provided, with the primary samples 12 having, for example—cyan, magenta, and yellow—pigments to form a primary color system capable of producing a wider spectrum of colors by mixing. In either case, primary samples 12 haying black and/or white pigments can be added to facilitate darkening and lightening the object being made.

FIG. 2 is a plan view of an alternative version 22 of a color mixing set built in accordance with the present invention, shown with the lid 20 removed therefrom, to reveal a first container 24 that is divided into compartments 26 separately holding the primary samples 12.

FIG. 3 is a cross-sectional elevation of a plan view of a second alternative version 28 of a color mixing set built in accordance with the present invention. Both the first container 14 and the second container 18 fir within a third container 30, which is sealed with a lid 32+.

It is understood that, while various parts and features have been described with some degree of particularity, such descriptions have been given only by way of example, and that many variations are possible within the spirit and scope of the inventions, which is understood to be limited only by the appended claims.

What is claimed is:

1. A color mixing set comprising:
a plurality of primary samples, each of which is composed of a modeling compound and a pigment forming a different primary color;
at least one neutral sample, wherein each of the neutral samples is composed of a modeling compound without a pigment;
a first container holding the plurality of primary samples; and
at least one second container holding each of the neutral samples.

2. The color mixing set of claim 1, wherein
the first and second containers are stackable upon one another, and
the color mixing set additionally comprises a lid closing the uppermost container with the containers stacked upon one another.

3. The color mixing set of claim 1, wherein
the first and second containers are stackable upon one another, and
the color mixing set additionally comprises a third container holding the first and second containers stacked upon one another and a lid closing the third container.

4. The color mixing set of claim 1, wherein the first and second containers are composed of a transparent material.

5. The color mixing set of claim 1, wherein the first container is divided into a plurality of compartments, each holding one of the primary samples.

6. The color mixing set of claim 1, wherein the primary colors formed by the pigments in the primary samples are red, green, and yellow.

7. The color mixing set of claim 1, wherein the primary colors formed by the pigments in the primary samples are red, green, yellow, and blue.

8. The color mixing set of claim 1, wherein the primary colors formed by the pigments in the primary samples are cyan, magenta, and yellow.

9. The color mixing set of claim 1, additionally comprising a primary sample comprising thje modeling compound and a black pigment.

10. The color mixing set of claim 1, additionally comprising a primary sample comprising thje modeling compound and a black pigment.

11. The color mixing set of claim 1, the modeling compound is a modeling dough.

12. The color mixing set of claim 1, wherein the modeling compound is a modeling clay.
